(19) United States
(12) Patent Application Publication
(10) Pub. No.: US 2022/0159028 A1
(43) Pub. Date: May 19, 2022

(54) Generating Alerts Based on Continuous Monitoring of Third Party Systems

(71) Applicant: Bank of America Corporation, Charlotte, NC (US)

(72) Inventors: Abhishek Kumar, Telangana (IN); Nikhil Banwarilal Bagaria, Mumbai (IN)

(21) Appl. No.: 16/950,276

(22) Filed: Nov. 17, 2020

(51) Int. Cl. H04L 29/06; G06N 20/00

(52) U.S. Cl. CPC H04L 63/1433; G06N 20/00; H04L 63/1408

(57) ABSTRACT

Aspects of the disclosure relate to generating alerts based on continuous monitoring of third party systems. In some embodiments, a computing platform may receive asset inventory data of a third party computing system of an entity. Based on comparing the asset inventory data of the third party computing system to a list of security vulnerability definitions maintained in a common vulnerabilities and exposures database, the computing platform may identify vulnerabilities and send a notification to the third party computing system of the identified vulnerabilities. Then, the computing platform may request implementation of remediation actions, by the third party computing system of the first entity, for the identified vulnerabilities within a predefined period of time. Next, the computing platform may receive a status of the remediation actions. Based on the third party computing system of the first entity implementing the remediation actions, the computing platform may store updated asset inventory data.

### BACKGROUND

Aspects of the disclosure relate to computer system security and identifying vulnerabilities from third-party systems. In particular, one or more aspects of the disclosure relate to generating alerts based on continuous monitoring of third party systems.

Information security is of utmost importance in many different industries. In particular, large enterprise organizations may make every attempt to identify information security incidents, remediate incidents, and the like. In many instances, however, due to the sheer volume of third party vendors with whom such organizations may interact, along with the different services and various different technologies such vendors may use in serving such a large enterprise organization, it may be difficult for an enterprise organization to detect, monitor, and manage system vulnerabilities effectively, efficiently, and in a continuous manner.

### SUMMARY

Aspects of the disclosure provide effective, efficient, scalable, and convenient technical solutions that address and overcome the technical problems associated with detecting, monitoring, and managing vulnerabilities from third-party systems (e.g., systems that may be owned, operated, and/or controlled by an entity different from an organization performing the detecting and/or monitoring). In particular, one or more aspects of the disclosure provide techniques for generating alerts based on continuous monitoring of third party systems. Some aspects of the disclosure provide ways to proactively monitor and identify vulnerabilities. Additional aspects of the disclosure may provide notifications and alerts as to remediation actions taken in connection with the identified vulnerabilities. Further additional aspects of the disclosure may prevent security breaches due to third parties using vulnerable technologies. Exposure of an enterprise's applications and data to third party system vulnerabilities may be minimized or prevented. Further additional aspects of the disclosure may aid in incident management and provide an improved security posture.

In accordance with one or more embodiments, a computing platform having at least one processor, a memory, and a communication interface may receive, via the communication interface, first asset inventory data of a third party computing system of a first entity. Subsequently, the computing platform may identify one or more vulnerabilities based on comparing the first asset inventory data of the third party computing system of the first entity to a list of security vulnerability definitions maintained in a common vulnerabilities and exposures database. Thereafter, the computing platform may send, via the communication interface, to the third party computing system of the first entity, a notification of the identified one or more vulnerabilities. Then, the computing platform may request implementation of one or more remediation actions, by the third party computing system of the first entity, for the identified one or more vulnerabilities within a predefined period of time. Next, the computing platform may receive, via the communication interface, a status of the one or more remediation actions. Based on the third party computing system of the first entity implementing the one or more remediation actions, the computing platform may store updated first asset inventory data of the third party computing system of the first entity.

In some embodiments, the computing platform may receive, via the communication interface, second asset inventory data of a third party computing system of a second entity. Subsequently, the computing platform may identify one or more vulnerabilities based on comparing the second asset inventory data of the third party computing system of the second entity to a list of security vulnerability definitions maintained in the common vulnerabilities and exposures database. Thereafter, the computing platform may send, via the communication interface, to the third party computing system of the second entity, a notification of the identified one or more vulnerabilities. Then, the computing platform may request implementation of one or more remediation actions, by the third party computing system of the second entity, for the identified one or more vulnerabilities within a predefined period of time. Next, the computing platform may receive, via the communication interface, a status of the one or more remediation actions. Based on the third party computing system of the second entity implementing the one or more remediation actions, the computing platform may store updated second asset inventory data of the third party computing system of the second entity.

In some embodiments, the first entity and the second entity are different third party entities. In some embodiments, the identified one or more vulnerabilities may include one or more security vulnerabilities associated with an asset. In some embodiments, the identified one or more vulnerabilities may include a zero-day vulnerability.

In some embodiments, the computing platform may detect common issues across a vendor landscape based on the first asset inventory data and the second asset inventory data. Then, the computing platform may generate a report on the common issues.

In some embodiments, the computing platform may detect common issues across a vendor landscape based on the first asset inventory data and the second asset inventory data. Then, the computing platform may generate notifications to a third entity different from the first entity and the second entity based on the detected common issues.

In some embodiments, requesting implementation of the one or more remediation actions for the identified one or more vulnerabilities may include requesting implementation of one or more remediation actions based on a severity level of the identified one or more vulnerabilities.

In some embodiments, the computing platform may update a machine learning classification model based on remediation actions. In addition, the machine learning classification model may be configured to automatically prioritize cybersecurity risks for remediation.

In some embodiments, receiving the first asset inventory data may include receiving the first asset inventory data at periodic time intervals. In some embodiments, receiving the first asset inventory data may include receiving the first asset inventory data at monthly time intervals.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for generating alerts based on continuous monitoring of third party systems in accordance with one or more example embodiments;

FIGS. 2A-2C depict an illustrative event sequence for generating alerts based on continuous monitoring of third party systems in accordance with one or more example embodiments;

FIG. 3 depicts an example graphical user interface for generating alerts based on continuous monitoring of third party systems in accordance with one or more example embodiments; and

FIG. 4 depicts an illustrative method for generating alerts based on continuous monitoring of third party systems in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

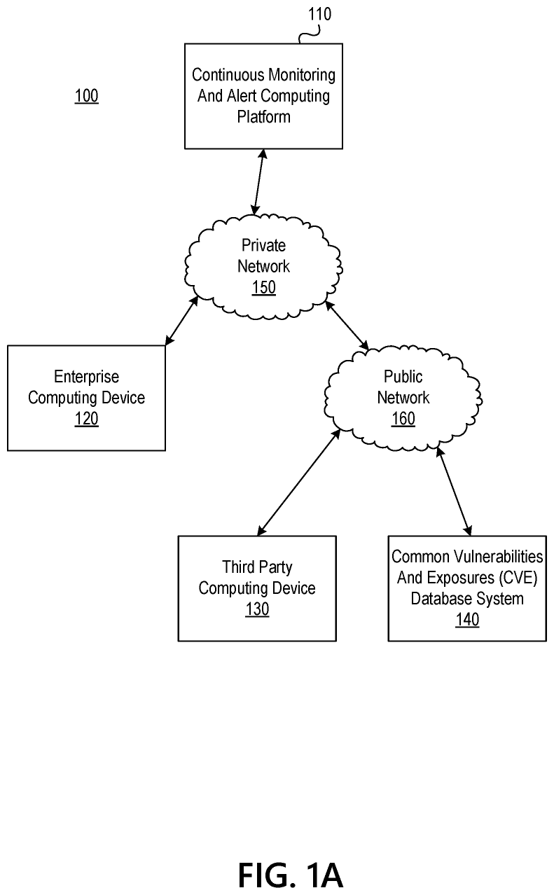

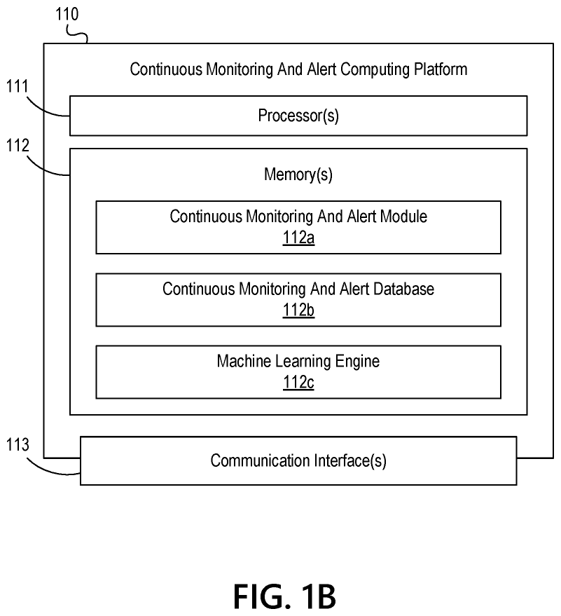

FIGS. 1A and 1B depict an illustrative computing environment for generating alerts based on continuous monitoring of third party systems in accordance with one or more example embodiments. Referring to FIG. 1A, computing environment 100 may include one or more computer systems. For example, computing environment 100 may include a continuous monitoring and alert computing platform 110, enterprise computing device 120, a third party computing device 130, and a common vulnerabilities and exposures (CVE) database system 140. Although one enterprise computing device 120 is shown for illustrative purposes, any number of enterprise computing devices may be used without departing from the disclosure. In addition, although one third party computing device 130 is shown for illustrative purposes, any number of third party computing devices may be used without departing from the disclosure.

As illustrated in greater detail below, continuous monitoring and alert computing platform 110 may include one or more computing devices configured to perform one or more of the functions described herein. For example, continuous monitoring and alert computing platform 110 may include one or more computers (e.g., laptop computers, desktop computers, servers, server blades, or the like). In some embodiments, continuous monitoring and alert computing platform 110 may include a system of records.

Enterprise computing device 120 may include one or more computing devices and/or other computer components (e.g., processors, memories, communication interfaces). For instance, enterprise computing device 120 may be a server, desktop computer, laptop computer, tablet, mobile device, or the like, and may be associated with an enterprise organization operating continuous monitoring and alert computing platform 110. Third party computing device 130 may include one or more computing devices and/or other computer components (e.g., processors, memories, communication interfaces). For instance, third party computing device 130 may be a server, desktop computer, laptop computer, tablet, mobile device, or the like, and may be used by a third party entity (e.g., a third party vendor outside of the enterprise organization operating continuous monitoring and alert computing platform 110).

Computing environment 100 also may include one or more networks, which may interconnect one or more of continuous monitoring and alert computing platform 110, enterprise computing device 120, third party computing device 130, and CVE database system 140. For example, computing environment 100 may include private network 150 and public network 160. Private network 150 and/or public network 160 may include one or more sub-networks (e.g., local area networks (LANs), wide area networks (WANs), or the like). Private network 150 may be associated with a particular organization (e.g., a corporation, financial institution, educational institution, governmental institution, or the like) and may interconnect one or more computing devices associated with the organization. For example, continuous monitoring and alert computing platform 110, enterprise computing device 120, third party computing device 130, and CVE database system 140 may be associated with an organization (e.g., a financial institution), and private network 150 may be associated with and/or operated by the organization, and may include one or more networks (e.g., LANs, WANs, virtual private networks (VPNs), or the like) that interconnect continuous monitoring and alert computing platform 110, enterprise computing device 120, third party computing device 130, and CVE database system 140 and one or more other computing devices and/or computer systems that are used by, operated by, and/or otherwise associated with the organization. Public network 160 may connect private network 150 and/or one or more computing devices connected thereto (e.g., continuous monitoring and alert computing platform 110, enterprise computing device 120, third party computing device 130, and CVE database system 140) with one or more networks and/or computing devices that are not associated with the organization. For example, third party computing device 130 might not be associated with an organization that operates private network 150, and public network 160 may include one or more networks (e.g., the Internet) that connect customer computing device 150 to private network 150 and/or one or more computing devices connected thereto (e.g., continuous monitoring and alert computing platform 110, enterprise computing device 120, third party computing device 130, and CVE database system 140).

In one or more arrangements, continuous monitoring and alert computing platform 110, enterprise computing device 120, third party computing device 130, and CVE database system 140 may be any type of computing device capable of receiving a user interface, receiving input via the user interface, and communicating the received input to one or more other computing devices. For example, continuous monitoring and alert computing platform 110, enterprise computing device 120, third party computing device 130, CVE database system 140, and/or the other systems included in computing environment 100 may, in some instances, include one or more processors, memories, communication interfaces, storage devices, and/or other components. As noted above, and as illustrated in greater detail below, any and/or all of the computing devices included in computing environment 100 may, in some instances, be special-purpose computing devices configured to perform specific functions.

Referring to FIG. 1B, continuous monitoring and alert computing platform 110 may include one or more processor(s) 111, memory(s) 112, and communication interface(s) 113. A data bus may interconnect processor 111, memory 112, and communication interface 113. Communication interface 113 may be a network interface configured to support communication between continuous monitoring and alert computing platform 110 and one or more networks (e.g., private network 150, public network 160, or the like). Memory 112 may include one or more program modules having instructions that when executed by processor 111 cause continuous monitoring and alert computing platform 110 to perform one or more functions described herein and/or one or more databases and/or other libraries that may store and/or otherwise maintain information which may be used by such program modules and/or processor 111.

In some instances, the one or more program modules and/or databases may be stored by and/or maintained in different memory units of continuous monitoring and alert computing platform 110 and/or by different computing devices that may form and/or otherwise make up continuous monitoring and alert computing platform 110. For example, memory 112 may have, store, and/or include a continuous monitoring and alert module 112a, a continuous monitoring and alert database 112b, and a machine learning engine 112c. Continuous monitoring and alert module 112a may have instructions that direct and/or cause continuous monitoring and alert computing platform 110 to, for example, detect, monitor, and manage third party system vulnerabilities, as discussed in greater detail below. Continuous monitoring and alert database 112b may store information used by continuous monitoring and alert module 112a and/or continuous monitoring and alert computing platform 110 in detecting, monitoring, and managing third party system vulnerabilities and/or in performing other functions, as discussed in greater detail below. Machine learning engine 112c may have instructions that direct and/or cause continuous monitoring and alert computing platform 110 to set, define, and/or iteratively redefine rules, techniques and/or other parameters used by continuous monitoring and alert computing platform 110 and/or other systems in computing environment 100 in, for example, automatically detecting or learning common issues, and automatically prioritizing cybersecurity risks for remediation.

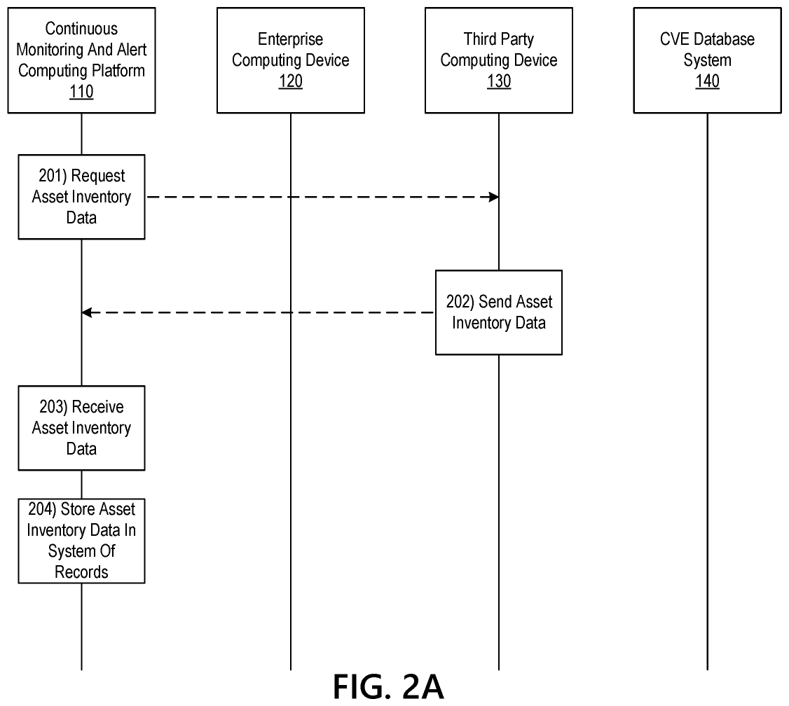

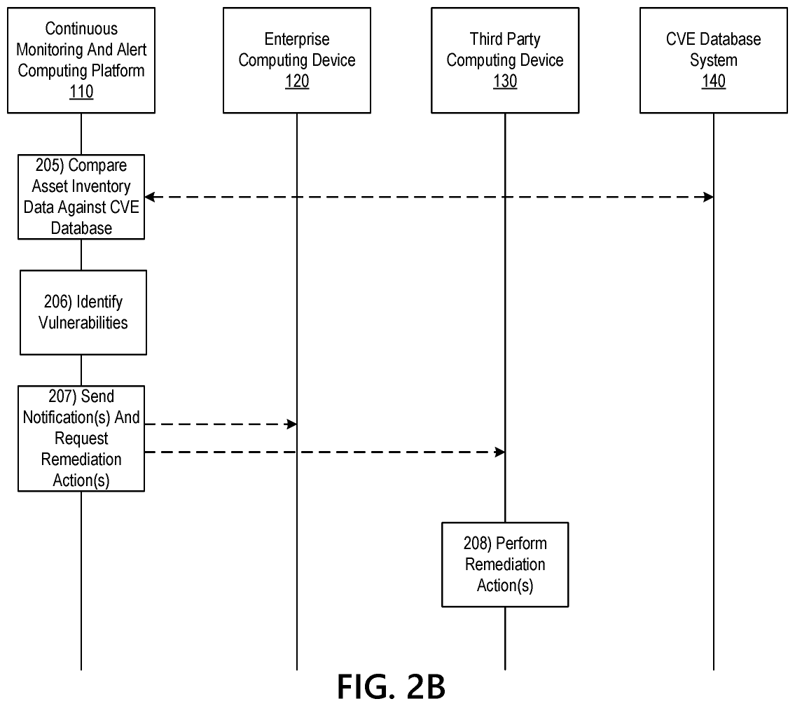

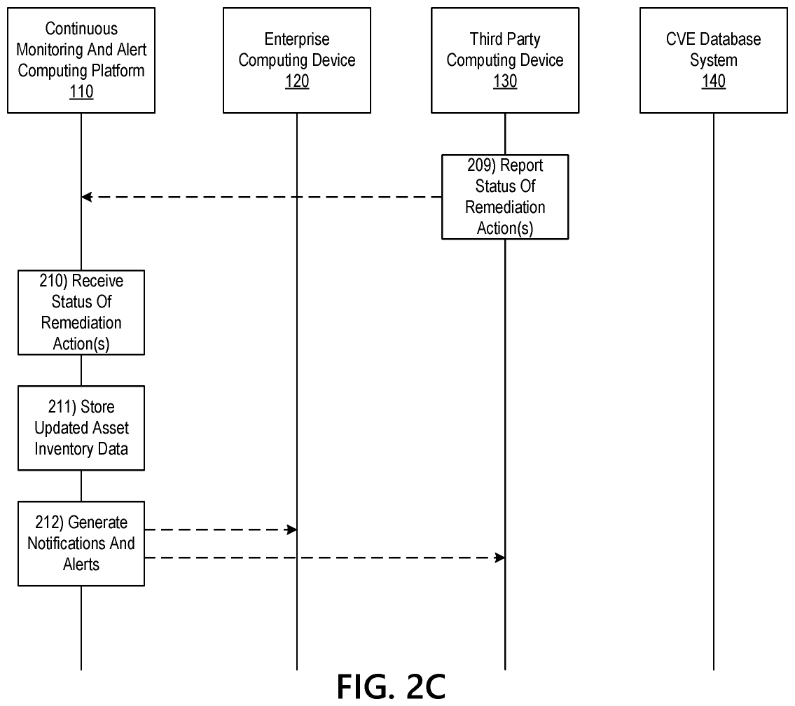

FIGS. 2A-2C depict an illustrative event sequence for generating alerts based on continuous monitoring of third party systems in accordance with one or more example embodiments. Referring to FIG. 2A, at step 201, continuous monitoring and alert computing platform 110 may send, via the communication interface (e.g., communication interface 113), a request for asset inventory data. For example, continuous monitoring and alert computing platform 110 may send a request for asset inventory data from a third party computing system of a first entity (e.g., third party computing device 130). In response to the request, the third party computing system (e.g., third party computing device 130) may, at step 202, send the asset inventory data to continuous monitoring and alert computing platform 110. In turn, at step 203, continuous monitoring and alert computing platform 110 may receive, via the communication interface (e.g., communication interface 113), the asset inventory data of the third party computing system of the first entity (e.g., third party computing device 130). In some examples, in receiving the asset inventory data, continuous monitoring and alert computing platform 110 may receive information indicating an asset type (e.g., whether the asset is hardware or software), a name of the asset, a version number, a count (e.g., how many instances of the asset are used), a build number, a knowledge base number, and/or other additional information identifying the asset inventory data. In some examples, the asset inventory data may be received at periodic time intervals. In some examples, the asset inventory data may be received at periodic time intervals (e.g., monthly, weekly) or non-periodically (e.g., dynamically) based on a user setting or request. In some embodiments, continuous monitoring and alert computing platform 110 may receive or capture information on the asset inventory data in the form of a template or spreadsheet completed by a third party entity (e.g., third party vendor), via electronic mail messaging, or via an automated system or script (e.g., a computer program), or any suitable combination of the preceding, or the like. In some embodiments, at step 204, continuous monitoring and alert computing platform 110 may store the asset inventory data in one or more databases. For example, the asset inventory data (e.g., for each vendor) may be stored in a system of records.

Referring to FIG. 2B, at step 205, continuous monitoring and alert computing platform 110 may compare the asset inventory data of the third party computing system of the first entity to a list of security vulnerability definitions maintained in vulnerabilities database. Such a database may include, for example, a common vulnerabilities and exposures (CVE) database storing a list of known information security vulnerabilities and exposures (e.g., CVE data). For example, when new data is received from a third party computing system (e.g., asset inventory feed), continuous monitoring and alert computing platform 110 may run a comparison of the asset inventory feed against the CVE data in order to check for potential vulnerabilities and/or to determine the potential scope of impact that potential vulnerabilities may have on an enterprise organization (e.g., how many third party systems are impacted). Based on the comparison at step 205, continuous monitoring and alert computing platform 110 may, at step 206, identify one or more vulnerabilities (e.g., based on identifying matches between the asset inventory feed and the CVE data). In some examples, the identified one or more vulnerabilities may include one or more security vulnerabilities associated with an asset (e.g., a software or hardware asset used by a third party vendor). For instance, the identified one or more vulnerabilities may include a zero-day vulnerability (e.g., a known security flaw for which there is no known patch or fix). In some embodiments, identifying the one or more vulnerabilities (e.g., third party vulnerabilities) may include assigning a severity level to the one or more vulnerabilities. In some embodiments, the level may identify a level of risk, urgency, or impact of a vulnerability to a business, clients, and/or the like.

Additionally or alternatively, in some embodiments, continuous monitoring and alert computing platform 110 may detect or learn common issues across a vendor landscape based on first asset inventory data and second asset inventory data, and generate internal reports on the common issues. For example, in or after identifying one or more vulnerabilities at step 206, continuous monitoring and alert computing platform 110 may, based on the identified one or more vulnerabilities, generate internal reports to the enterprise organization that may include a list or status of current vulnerabilities (e.g., newly discovered vulnerabilities), a list or status of outstanding vulnerabilities (e.g., previously identified or reported vulnerabilities), timestamps of when one or more vulnerabilities were identified or reported, and/or expected remediation timeframes of one or more vulnerabilities. Additionally or alternatively, in some embodiments, continuous monitoring and alert computing platform 110 may detect or learn common issues across a vendor landscape based on first asset inventory data and second asset inventory data, and generate external notifications to various different entities based on the detected or learned common issues. For example, in or after identifying one or more vulnerabilities at step 206, continuous monitoring and alert computing platform 110 may, based on the identified one or more vulnerabilities, generate external notifications to various third party entities (e.g., various different third party vendors, administrators, or service providers) that may include a list or status of current vulnerabilities (e.g., newly discovered vulnerabilities), a list or status of outstanding vulnerabilities (e.g., previously identified or reported vulnerabilities), timestamps of when one or more vulnerabilities were identified or reported, and/or expected remediation timeframes of one or more vulnerabilities.

At step 207, continuous monitoring and alert computing platform 110 may send, via the communication interface (e.g., communication interface 113), a notification of the identified one or more vulnerabilities to the third party computing system (e.g., enterprise computing device 120). Additionally, continuous monitoring and alert computing platform 110 may send, via the communication interface (e.g., communication interface 113), the notification of the identified one or more vulnerabilities to the enterprise's computer system (e.g., enterprise computing device 120). In some embodiments, at step 207, in sending the notification of the identified one or more vulnerabilities to the third party computing system (e.g., enterprise computing device 120), continuous monitoring and alert computing platform 110 may generate commands to the third party computing system (e.g., enterprise computing device 120) requesting implementation of one or more remediation actions (e.g., within a predefined period of time). For example, continuous monitoring and alert computing platform 110 may request implementation of one or more remediation actions based on a severity level of the identified one or more vulnerabilities. In some examples, continuous monitoring and alert computing platform 110 may send different types of notifications based on different types of identified vulnerabilities. In some examples, continuous monitoring and alert computing platform 110 may build and maintain a template library for the notifications.

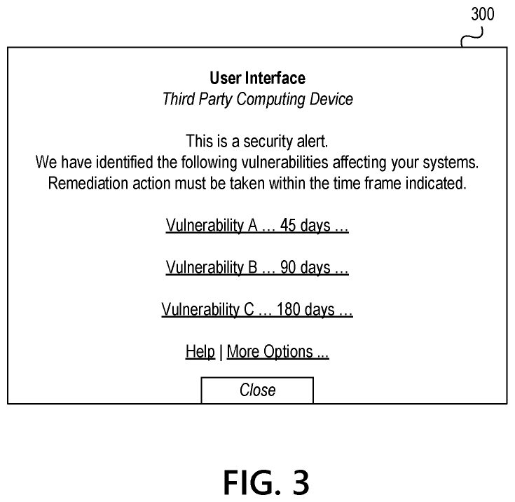

In some embodiments, sending the notification of the identified one or more vulnerabilities to the third party computing system (e.g., enterprise computing device 120) may, at step 208, cause the third party computing system (e.g., enterprise computing device 120) to receive the notification (e.g., with remediation commands) from the continuous monitoring and alert computing platform 110 and display a graphical representation of the notification at the third party computing system (e.g., enterprise computing device 120). For instance, continuous monitoring and alert computing platform 110 may, at step 208, cause the affected third party computing system (e.g., enterprise computing device 120) to display and/or otherwise present one or more graphical user interfaces similar to graphical user interface 300, which is illustrated in FIG. 3. As seen in FIG. 3, graphical user interface 300 may include text and/or other information notifying a third party computing system (e.g., enterprise computing device 120) of the identified one or more vulnerabilities (e.g., third party vulnerabilities) and text and/or other information indicating as to when the third party computing system (e.g., enterprise computing device 120) is expected to take remediation action (e.g., “Vulnerability A . . . 45 days”, “Vulnerability B . . . 90 days”, “Vulnerability C . . . 180 days”). Additionally or alternatively, continuous monitoring and alert computing platform 110 may update a machine learning classification model based on remediation actions. In addition, the machine learning classification model may be configured to automatically prioritize cybersecurity risks for remediation (e.g., critical, less critical, or non-critical). In examples where some vulnerability issues may be riskier than others, continuous monitoring and alert computing platform 110 may use the machine learning classification model to prioritize them for resolution. For example, in using the machine learning classification model, continuous monitoring and alert computing platform 110 may classify common vulnerabilities based on their potential impacts (e.g., to an enterprise organization), generate vulnerability scores (e.g., Common Vulnerability Scoring System (CVSS) scores) for one or more security vulnerabilities associated with an asset, prioritize which vulnerabilities to address first, and/or provide behavior forecasting of one or more assets (e.g., based on historical trends for different technology assets). In turn, the continuous monitoring and alert computing platform 110 may cause the third party computing system (e.g., enterprise computing device 120) to execute the remediation commands.

Referring to FIG. 2C, at step 209, the third party computing system (e.g., enterprise computing device 120) may report, and at step 210, continuous monitoring and alert computing platform 110 may receive, via the communication interface (e.g., communication interface 113), a status of one or more remediation actions that were taken by the third party computing system (e.g., enterprise computing device 120). Such remediation actions may include executing a set of actions within a predefined period of time to minimize negative impacts based upon a level of materiality or severity of a vulnerability (e.g., executing a patch to cure the vulnerability).

At step 211, based on the third party computing system (e.g., enterprise computing device 120) implementing the one or more remediation actions, continuous monitoring and alert computing platform 110 may store updated asset inventory data reflecting the remediation actions that were taken at step 208).

At step 212, continuous monitoring and alert computing platform 110 may generate notifications and/or alerts to one or more computing devices (e.g., enterprise computing device 120, third party computing system 130). For example, continuous monitoring and alert computing platform 110 may generate notification and/or alerts indicating that an asset inventory update process is complete or that certain required remediation actions are still outstanding. For instance, continuous monitoring and alert computing platform 110 may take escalation steps based on the type and/or severity of a vulnerability still outstanding. Such escalation steps may include sending notification and/or alerts to a vendor management team within an enterprise organization or sending notification and/or alerts to a third party stakeholder. Severity levels may include, for example, “critical,” “high,” “medium,” or “low” severity rankings. Subsequently, continuous monitoring and alert computing platform 110 may repeat one or more steps of the example event sequence discussed above in providing generating alerts based on continuous monitoring of third party systems (e.g., for additional or different third party entities).

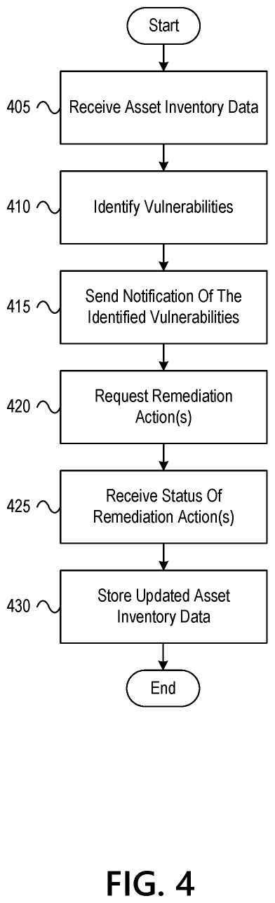

FIG. 4 depicts an illustrative method for generating alerts based on continuous monitoring of third party systems in accordance with one or more example embodiments. Referring to FIG. 4, at step 405, a computing platform having at least one processor, a communication interface, and memory may receive, via the communication interface, first asset inventory data of a third party computing system of a first entity. At step 410, the computing platform may identify one or more vulnerabilities based on comparing the first asset inventory data of the third party computing system of the first entity to a list of security vulnerability definitions maintained in a common vulnerabilities and exposures database. At step 415, the computing platform may send, via the communication interface, to the third party computing system of the first entity, a notification of the identified one or more vulnerabilities. At step 420, the computing platform may request implementation of one or more remediation actions, by the third party computing system of the first entity, for the identified one or more vulnerabilities within a predefined period of time. At step 425, the computing platform may receive, via the communication interface, a status of the one or more remediation actions. At step 430, based on the third party computing system of the first entity implementing the one or more remediation actions, the computing platform may store updated first asset inventory data of the third party computing system of the first entity.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
receive, via the communication interface, first asset inventory data of a third party computing system of a first entity;
identify one or more vulnerabilities based on comparing the first asset inventory data of the third party computing system of the first entity to a list of security vulnerability definitions maintained in a common vulnerabilities and exposures database;
send, via the communication interface, to the third party computing system of the first entity, a notification of the identified one or more vulnerabilities;
request implementation of one or more remediation actions, by the third party computing system of the first entity, for the identified one or more vulnerabilities within a predefined period of time;
receive, via the communication interface, a status of the one or more remediation actions; and
based on the third party computing system of the first entity implementing the one or more remediation actions, store updated first asset inventory data of the third party computing system of the first entity.

2. The computing platform of claim 1, wherein the memory stores additional computer-readable instructions that, when executed by the at least one processor, cause the computing platform to:
receive, via the communication interface, second asset inventory data of a third party computing system of a second entity;
identify one or more vulnerabilities based on comparing the second asset inventory data of the third party computing system of the second entity to a list of security vulnerability definitions maintained in the common vulnerabilities and exposures database;
send, via the communication interface, to the third party computing system of the second entity, a notification of the identified one or more vulnerabilities;
request implementation of one or more remediation actions, by the third party computing system of the second entity, for the identified one or more vulnerabilities within a predefined period of time;
receive, via the communication interface, a status of the one or more remediation actions; and
based on the third party computing system of the second entity implementing the one or more remediation actions, store updated second asset inventory data of the third party computing system of the second entity.

3. The computing platform of claim 2, wherein the first entity and the second entity are different third party entities.

4. The computing platform of claim 2, wherein the identified one or more vulnerabilities comprise one or more security vulnerabilities associated with an asset.

5. The computing platform of claim 2, wherein the identified one or more vulnerabilities comprise a zero-day vulnerability.

6. The computing platform of claim 2, wherein the memory stores additional computer-readable instructions that, when executed by the at least one processor, cause the computing platform to:
detect common issues across a vendor landscape based on the first asset inventory data and the second asset inventory data; and
generate a report on the common issues.

7. The computing platform of claim 2, wherein the memory stores additional computer-readable instructions that, when executed by the at least one processor, cause the computing platform to:
detect common issues across a vendor landscape based on the first asset inventory data and the second asset inventory data; and
generate notifications to a third entity different from the first entity and the second entity based on the detected common issues.

8. The computing platform of claim 1, wherein requesting implementation of the one or more remediation actions for the identified one or more vulnerabilities comprises requesting implementation of one or more remediation actions based on a severity level of the identified one or more vulnerabilities.

9. The computing platform of claim 1, wherein the memory stores additional computer-readable instructions that, when executed by the at least one processor, cause the computing platform to:
update a machine learning classification model based on remediation actions, wherein the machine learning classification model is configured to automatically prioritize cybersecurity risks for remediation.

10. The computing platform of claim 1, wherein receiving the first asset inventory data comprises receiving the first asset inventory data at periodic time intervals.

11. The computing platform of claim 1, wherein receiving the first asset inventory data comprises receiving the first asset inventory data at monthly time intervals.

12. A method, comprising:
at a computing platform comprising at least one processor, a communication interface, and memory:
receiving, by the at least one processor, via the communication interface, first asset inventory data of a third party computing system of a first entity;
identifying, by the at least one processor, one or more vulnerabilities based on comparing the first asset inventory data of the third party computing system of the first entity to a list of security vulnerability definitions maintained in a common vulnerabilities and exposures database;
sending, by the at least one processor, via the communication interface, to the third party computing system of the first entity, a notification of the identified one or more vulnerabilities;
requesting, by the at least one processor, implementation of one or more remediation actions, by the third party computing system of the first entity, for the identified one or more vulnerabilities within a predefined period of time;
receiving, by the at least one processor, via the communication interface, a status of the one or more remediation actions; and
based on the third party computing system of the first entity implementing the one or more remediation actions, storing, by the at least one processor, updated first asset inventory data of the third party computing system of the first entity.

13. The method of claim 12, further comprising:
receiving, by the at least one processor, via the communication interface, second asset inventory data of a third party computing system of a second entity;
identifying, by the at least one processor, one or more vulnerabilities based on comparing the second asset inventory data of the third party computing system of the second entity to a list of security vulnerability definitions maintained in the common vulnerabilities and exposures database;
sending, by the at least one processor, via the communication interface, to the third party computing system of the second entity, a notification of the identified one or more vulnerabilities;
requesting, by the at least one processor, implementation of one or more remediation actions, by the third party computing system of the second entity, for the identified one or more vulnerabilities within a predefined period of time;
receiving, by the at least one processor, via the communication interface, a status of the one or more remediation actions; and
based on the third party computing system of the second entity implementing the one or more remediation actions, storing, by the at least one processor, updated second asset inventory data of the third party computing system of the second entity.

14. The method of claim 13, wherein the first entity and the second entity are different third party entities.

15. The method of claim 13, wherein the identified one or more vulnerabilities comprise one or more security vulnerabilities associated with an asset.

16. The method of claim 13, further comprising:
detecting, by the at least one processor, common issues across a vendor landscape based on the first asset inventory data and the second asset inventory data; and
generating, by the at least one processor, a report on the common issues.

17. The method of claim 13, further comprising:
detecting, by the at least one processor, common issues across a vendor landscape based on the first asset inventory data and the second asset inventory data; and
generating, by the at least one processor, notifications to a third entity different from the first entity and the second entity based on the detected common issues.

18. The method of claim 12, wherein requesting implementation of the one or more remediation actions for the identified one or more vulnerabilities comprises requesting implementation of one or more remediation actions based on a severity level of the identified one or more vulnerabilities.

19. The method of claim 12, further comprising:
updating, by the at least one processor, a machine learning classification model based on remediation actions, wherein the machine learning classification model is configured to automatically prioritize cybersecurity risks for remediation.

20. One or more non-transitory computer-readable media storing instructions that, when executed by a computing platform comprising at least one processor, a communication interface, and memory, cause the computing platform to:
receive, via the communication interface, first asset inventory data of a third party computing system of a first entity;
identify one or more vulnerabilities based on comparing the first asset inventory data of the third party computing system of the first entity to a list of security vulnerability definitions maintained in a common vulnerabilities and exposures database;
send, via the communication interface, to the third party computing system of the first entity, a notification of the identified one or more vulnerabilities;
request implementation of one or more remediation actions, by the third party computing system of the first entity, for the identified one or more vulnerabilities within a predefined period of time;
receive, via the communication interface, a status of the one or more remediation actions; and
based on the third party computing system of the first entity implementing the one or more remediation actions, store updated first asset inventory data of the third party computing system of the first entity.
